(19) United States
(12) Patent Application Publication
(10) Pub. No.: US 2011/0103999 A1
(43) Pub. Date: May 5, 2011

(54) METAL COATING FORMING METHOD AND AEROSPACE STRUCTURAL MEMBER

(76) Inventors: Kazuyuki Oguri, Aichi (JP); Makoto Senda, Aichi (JP); Takahiro Sekigawa, Aichi (JP)

(21) Appl. No.: 13/000,092

(22) PCT Filed: Aug. 20, 2009
(86) PCT No.: PCT/JP2009/064567

§ 371 Date: Dec. 20, 2010

(30) Foreign Application Priority Data
Aug. 25, 2008 (JP) 2008-215768

(51) Int. Cl. B32B 15/04; B05D 1/12; C22C 9/00

(52) U.S. Cl. 420/469; 427/180

(57) ABSTRACT

Provided are a method for forming a metal coating at high speed by using a simple cold spray apparatus, and an aerospace structural member on which a metal coating is formed by the cold spray method. In the metal coating forming method, nonspherical heteromorphous particles made of metal are projected onto a base material surface by the cold spray method to form a metal coating on the base material surface.

### TECHNICAL FIELD

The present invention relates to a metal coating forming method and an aerospace structural member on which a metal coating is formed.

### BACKGROUND ART

A resin-based composite material that includes resin, such as fiber reinforced plastic, or an aluminum alloy is used for a structural member of an aircraft, etc. Since the resin-based composite material includes resin having low conductivity as its base, when it is used for an aircraft main-wing structural member, for example, a layer having conductivity (lightning-resistant layer) is formed on a surface thereof in order to impart lightning resistance to the aircraft main-wing structural member. As a method for forming a lightning-resistant layer on a surface of the resin-based composite material, a method for thermally bonding copper foil to the resin-based composite material at the same time as when the resin-based composite material is molded is known.

However, in the above-mentioned method, in which the copper foil is simultaneously thermally-bonded to the surface of the resin-based composite material, since resin and copper foil having different thermal expansion coefficients are bonded, low adhesion occurs and it is impossible to bond the copper foil to a large surface area of the resin-based composite material. There is also a problem in that the task of bonding thin copper foil to the surface of the resin-based composite material is technically difficult.

Thus, metal coating formation by a cold spray method has attracted attention (for example, see Non Patent Literature 1 and Non Patent Literature 2). In the cold spray method, metal particles are injected into gas having a temperature lower than the melting point or the softening temperature of the raw material metal, and the gas flow rate is increased to a supersonic flow to accelerate the speed of the metal particles to make them collide with the metal at high speed in the solid state, thereby causing the metal particles to plastically deform, aggregate and deposit to form a metal coating. Since the cold spray method allows the coating to be formed at room temperature without melting the metal particles with a high-temperature heat source such as a flame or plasma, it is effective when forming a coating of pure metal, which is easily oxidized.

Non Patent Literature 2 discloses a technology for forming a pure Al coating by a low-pressure type cold spray method in which the injection pressure is 1 MPa or less.

### CITATION LIST

### Non Patent Literature

{NPL 1} Kazuhiko SAKAKI, “Outline of cold spray and light metal coating thereof”, Journal of Japan Institute of Light Metals, Vol. 56, No. 7, 2006, pp. 376-385
{NPL 2} Kazuhiro OGAWA, et al., “Evaluation of mechanical properties of pure aluminum coating processed by low-pressure type cold spray”, Speech No. 214, Proceedings of 85th (Spring 2007) Conference, Japan Thermal Spraying Society

### SUMMARY OF INVENTION

### Technical Problem

In coating formation by the cold spray method, it is generally required to use spherical fine particles having a uniform particle diameter of 50 μm or less in order to readily form a coating. However, when spherical fine particles are used, there are problems in that the deposition efficiency is low (the coating formation speed is low); coating formation is possible only under proper conditions; when a resin-based composite material is used as a base material, the surface thereof is blasted; and spherical fine particles having a uniform particle diameter are expensive. In particular, when a coating is formed by the low-pressure type cold spray method in which the pressure of the injection gas is low, there is also a problem in that a coating formed of the spherical fine particles peels off when it reaches a certain thickness, and thus, only a thin coating can be formed.

Further, in the cold spray method, in order to improve the deposition efficiency, projectile particles that are obtained by mixing alumina particles into metal particles are used to form a coating at high speed, but this is unsuitable when forming a coating for which conductivity is required.

The present invention has been made in view of the above-described circumstances and provides a method for forming a metal coating at high speed by using a simple cold spray apparatus, and an aerospace structural member on which a metal coating is formed by the cold spray method.

### Solution to Problem

In order to solve the above-described problems, the present invention provides a metal coating forming method including projecting nonspherical heteromorphous particles made of metal onto a base material surface by a cold spray method to form a metal coating on the base material surface.

In the metal coating forming method of the present invention, nonspherical heteromorphous particles are used as projectile metal particles. The nonspherical heteromorphous particles used in the present invention are, for example, dendritic particles, flake-like particles, and the like. The “dendritic particles” are particles having a branched shape, and the “flake-like particles” are particles having a flat board-like shape. When the nonspherical heteromorphous particles are projected onto the base material surface, the particles are more likely to be entwined with each other, compared with spherical particles, to easily aggregate and deposit, thus improving the coating formation speed. In particular, when the resin-based composite material is used as the base material, blasting of the base material surface is suppressed. Therefore, a metal coating having excellent adhesion can be formed at high speed. Furthermore, by using the cold spray method, a coating of pure metal can be formed without oxidizing the metal. The metal coating forming method of the present invention is effective particularly when a thick metal coating having a thickness of 0.5 mm or more is formed.

In the above-described invention, it is preferable that a speed of forming the metal coating be 5 μm/s or more. With the above-described metal coating formation speed, a coating can be formed with high productivity.

In the above-described invention, the metal may be copper. When the cold spray method is used, a coating of copper used as a lightning-resistant layer on an aircraft main wing structural member, for example, can be formed without oxidization.

Further, the present invention provides an aerospace structural member on a surface of which a metal coating is formed using the above-described metal coating forming method.

When the metal coating forming method of the present invention is used, an aerospace structural member on which a coating of metal is formed can be obtained without oxidizing the metal. In particular, when a metal coating is formed on a resin-based composite material that includes resin, such as fiber reinforced plastic, it is advantageous because the base material surface is not likely to receive damage caused when it is blasted. Since the formed metal coating has excellent adhesion to the base material and high coating strength, it can be used as a lightning-resistant layer on an aircraft main wing structural member.

### Advantageous Effects of Invention

According to the present invention, it is possible to suppress blasting of the base material surface and to form a metal coating having excellent adhesion on the base material at high speed.

### BRIEF DESCRIPTION OF DRAWINGS

FIG. 1 is a schematic view for explaining a metal coating forming method according to this embodiment.

### DESCRIPTION OF EMBODIMENTS

A metal coating forming method according to an embodiment of the present invention will be described below.

A base material is made of a metal, such as an aluminum alloy, or a resin-based composite material, such as carbon fiber reinforced plastic (CFRP) or glass fiber reinforced plastic (GFRP). The base material is suitable for use in an aerospace structure, such as an aircraft main wing.

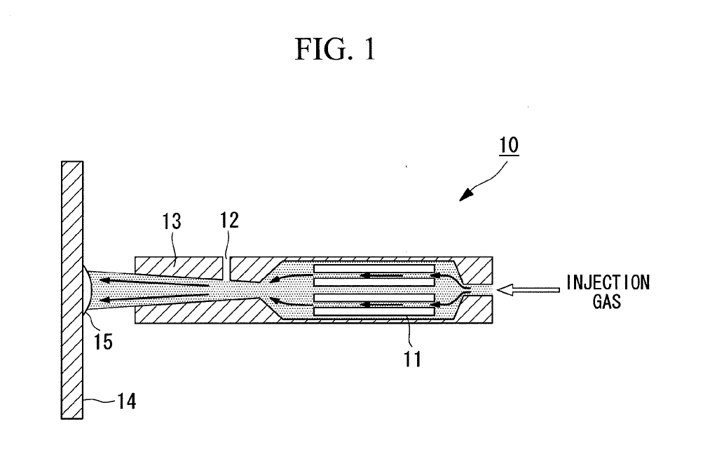

FIG. 1 is a schematic view for explaining the metal coating forming method of this embodiment. In this embodiment, a cold spray apparatus whose injection pressure is low is used. Injection gas introduced to a cold spray apparatus 10 is heated by a heater 11. The temperature to which the injection gas is heated at this time is lower than the melting point or the softening temperature of metal particles of the raw material. When the metal particles are injected into the heated injection gas from a projectile particle inlet 12, the metal particles are heated by the injection gas. The injection gas is increased in speed to a supersonic flow in a supersonic nozzle 13 and is injected into a base material 14 from the tip of the nozzle 13. Together with the injection gas, the heated metal particles are increased in speed and projected onto the base material 14. The metal particles projected onto the base material 14 collide with the base material 14 in the solid state. Thus, the metal particles plastically deform, aggregate and deposit on the surface of the base material, thereby forming a metal coating 15.

As the projectile metal particles, it is preferable to use copper particles, but aluminum particles can also be used. The projectile metal particles are nonspherical heteromorphous particles. Nonspherical heteromorphous particles mean particles having a shape other than a spherical shape, such as dendritic particles and flake-like particles, for example. In particular, dendritic particles that are produced by an electrolytic process easily plastically deform because they are relatively soft and have excellent heat conductivity; and further, because the particles are entwined with each other due to the plastic deformation, they easily deposit. Therefore, they are suitable for forming a metal coating at high speed. The size of each of the projected metal particles is equal to or smaller than 100 μm, preferably, from 10 μm to 50 μm, inclusive.

If spherical particles are projected onto the base material surface by using a simple cold spray apparatus, high-speed coating formation cannot be achieved because the deposition efficiency is low. Furthermore, since the coating easily peels off as the thickness thereof is increased, a thick coating having a thickness of 0.5 mm or more, for example, cannot be formed. Depending on the conditions, the base material may be subjected to blasting adversely. In particular, when the base material is made of CFRP or GFRP, it is easily blasted, and fibers contained therein are damaged.

The injection pressure is set from 0.1 MPa to 0.9 MPa, inclusive, preferably, from 0.4 MPa to 0.6 MPa, inclusive. If the injection pressure is less than 0.1 MPa, a stable injection state cannot be maintained.

The distance between the nozzle of the cold spray apparatus and the base material is set from 5 mm to 100 mm, inclusive, preferably, from 10 mm to 30 mm, inclusive. If the distance therebetween is less than 5 mm, the base material is blasted, damaging fibers therein, or the deposited coating is blasted, making coating formation difficult. If the distance therebetween exceeds 100 mm, a coating cannot be formed.

The heater temperature of the cold spray apparatus is set equal to or higher than 200° C. and lower than 500° C., preferably, from 300° C. to 400° C., inclusive. Although the temperature of the base material varies according to the distance between the nozzle and the base material or according to the heater temperature, in this embodiment, it is set from 80° C. to 180° C., inclusive, preferably, from 120° C. to 150° C., inclusive. If the heater temperature is lower than 200° C., the projectile metal particles are not deposited on the base material, and the base material is blasted, damaging fibers therein. If the heater temperature is equal to or higher than 500° C., the projectile metal particles are melted and attached to the inner wall of the nozzle, which tends to block the nozzle; and the formed metal coating is oxidized, thus lowering the coating properties, for example, to reduce the conductivity.

Compressed air that has excellent ease of handling and is inexpensive is preferably used as injection gas. According to the metal coating forming method of this embodiment, even when compressed air is used as the injection gas, a metal coating can be formed without oxidization. However, to prevent coating oxidization more reliably, inert gas, such as helium or nitrogen, may be used.

If nonspherical heteromorphous particles, such as dendritic particles or flake-like particles, are projected onto the base material by the cold spray method under the above-described conditions, a metal coating is formed without oxidizing the metal particles. In particular, when a resin-based composite material, such as CFRP or GFRP, is used for the base material, a metal coating can be formed thereon without blasting the base material surface, thus preventing damage to the base material. Furthermore, with the above-described conditions, a high coating formation speed of 5 μm/s or more can be obtained. Therefore, the productivity can be improved. A metal coating formed by the method of this embodiment has excellent adhesion to the base material and excellent coating strength.

This embodiment is effective when a thick coating having a thickness of 0.5 mm or more is formed on the base material. However, so long as a property that is required for a metal coating, for example, conductivity, is satisfied, there is no problem to form a metal coating having a thickness less than 0.5 mm.

### EXAMPLES

### Effect of Metal Particle Shape

Under the conditions shown in Table 1, a copper coating was formed on a tensile jig (which was obtained by joining two copper specimens each having a diameter of 14 mm and a length of 17 mm) by the cold spray method. Note that cold spray conditions were set as follows: the injection pressure was 0.5 MPa; the nozzle distance was 10 mm; and the heater temperature was 300° C. (Example 2) or 400° C. (Examples 1 and 3, Comparative Examples 1 and 2). The temperature of the base material at the time of coating formation was measured as follows: approximately 120° C. in Example 2, and approximately 150° C. in Examples 1 and 3 and Comparative Examples 1 and 2.

The coating thickness and coating formation speed were obtained from a change in the diameter of the tensile jig before and after the coating formation. The tensile strength of each coating was measured. Table 1 shows the results thereof.

TABLE 1

| | | Coating | Coating formation | Coating |
|---|---|---|---|---|
| | Projected particles | thickness (mm) | speed (μm/s) | strength (Mpa) |
| Examples 1 | Copper dendritic electrolytic | 1.58 | 26.3 | 23.7 |
| | powders (size: 45 μm or less) | | | |
| Examples 2 | Copper dendritic electrolytic | 1.45 | 24.2 | 18.5 |
| | powders (size: 45 μm or less) | | | |
| Examples 3 | Copper flake-like powders | 0.67 | 5.6 | 32.3 |
| | (size: 30 μm or less) | | | |
| Comparative | Copper spherical atomized | 0.4 | 3.3 | 27.6 |
| example 1 | powders (size: 10 to 50 μm) | | | |
| Comparative | Alumina-particle-containing | 1.54 | 38.5 | 71.6 |
| example 2 | copper powders (size: 45 μm | | | |
| | or less) | | | |

In Example 1, Example 2 (dendritic), and Example 3 (flake-like), a coating having a thickness of 0.5 μm or more was formed at a speed of 5 μm/s. In particular, in Example 1 and Example 2, a metal coating having a thickness of 1.5 to 1.6 mm was formed. As the heater temperature was increased, a thick coating was formed. High coating formation speeds were obtained in the Examples although they were lower than that obtained in Comparative Example 2. On the other hand, in Comparative Example 1 (spherical), the coating formation speed was low, and it was difficult to form a thick coating.

The coating strengths obtained in Examples 1 to 3 were lower than that obtained in Comparative Example 2 but were all sufficient for a lightning-resistant layer on an aircraft main wing, for example.

In Example 3, the particles flowed in the cold spray apparatus more slowly than in Examples 1 and 2, so the coating formation speed was low. Furthermore, since the particles have a high thermal conductivity, the coating was likely to be oxidized. From the above-described results, it is particularly preferable that dendritic particles be used as the projectile particles.

### Effects of Nozzle Distance

A copper coating was formed on a base material (aluminum flat plate) by cold spraying under the conditions of Example 1. Furthermore, the nozzle distance set in Example 1 was changed to 30 mm and to 50 mm to form a copper coating in Examples 4 and 5, respectively. The cross-section surface of each copper coating was observed using an optical microscope to measure the thickness thereof, thereby obtaining the coating formation speed. Table 2 shows the results thereof.

TABLE 2

| | Coating formation |
|---|---|
| | speed (μm/s) |
| Examples 1 | 26.3 |
| Examples 4 | 21.2 |
| Examples 5 | 8.0 |

As the nozzle distance became longer, the coating formation speed was reduced. With a nozzle distance of 50 mm, coating formation was possible, but the coating formation speed was notably reduced.

### Effect of Heater Temperature

Under the same conditions of Example 1 except that the heater temperature was changed to 300° C. and to 500° C., a copper coating was formed on a base material (copper flat plate) in Examples 6 and 7, respectively. The oxidization of the coating was not observed in Examples 1 and 6, but it was visually confirmed that the coating surface had been oxidized in Example 7.

### REFERENCE SIGNS LIST

10 cold spray apparatus
11 heater
12 projectile particle inlet
13 supersonic nozzle
14 base material
15 metal coating

1. A metal coating forming method comprising projecting nonspherical heteromorphous particles made of metal onto a base material surface by a cold spray method to form a metal coating on the base material surface.

2. A metal coating forming method according to claim 1, wherein a speed of forming the metal coating is 5 μm/s or more.

3. A metal coating forming method according to claim 1, wherein the metal is copper.

4. An aerospace structural member on a surface of which a metal coating is formed using a metal coating forming method according to claim 1.
